(19) United States
(12) Patent Application Publication
(10) Pub. No.: US 2025/0370207 A1
(43) Pub. Date: Dec. 4, 2025

(54) OPTICAL FIBER CABLE

(71) Applicant: SUMITOMO ELECTRIC INDUSTRIES, LTD., Osaka (JP)

(72) Inventors: Keisuke MINATO, Osaka (JP); Fumiaki SATO, Osaka (JP); Kenta TSUCHIYA, Osaka (JP)

(21) Appl. No.: 19/221,706

(22) Filed: May 29, 2025

(30) Foreign Application Priority Data
May 31, 2024 (JP) 2024-088682

(51) Int. Cl. G02B 6/44

(52) U.S. Cl. CPC G02B 6/443

(57) ABSTRACT

An optical fiber cable includes a cable core including a plurality of optical fibers, at least one tensile strength member provided along an axis of the cable core, and a sheath covering the cable core from an outside and containing the tensile strength member. The sheath is flattened such that a long axis of the sheath overlaps a position where the tensile strength member is provided with respect to the cable core, in a cross-sectional view orthogonal to an axis of the optical fiber cable. A circularity of an outer diameter of the cable core is larger than a circularity of a surface layer of the sheath. The circularity of the surface layer of the sheath is 85% or more and 96% or less, in the cross-sectional view.

### CROSS-REFERENCE TO RELATED APPLICATIONS

This application is based on and claims priority under 35 USC 119 from Japanese Patent Application No. 2024-088682 filed on May 31, 2024, the entire content of which is incorporated herein by reference.

### TECHNICAL FIELD

The present disclosure relates to an optical fiber cable.

### BACKGROUND ART

WO2023/120478 A1 discloses an optical fiber cable laid in a duct such as a micro-duct using an air pumping method. In the optical fiber cable in WO2023/120478 A1, the circularity of the surface layer of the sheath is 85% or more in a cross section perpendicular to the axis of the optical fiber cable. With such a configuration, since the airtightness between the optical fiber cable and the inner surface of a cable insertion tube of a cable pump is improved, the pumping distance of the optical fiber cable can be extended.

In an optical fiber cable whose sheath contains a tensile strength member (a tension member, hereinafter also referred to as “TM”), the thickness of the sheath (hereinafter referred to as “TM outer sheath”) between the tensile strength member and the surface layer of the sheath in a direction from the tensile strength member toward the surface layer of the sheath in a cross-sectional view orthogonal to the axis of the optical fiber cable needs to be greater than or equal to a thickness defined by the standard. When pressure is applied to the optical fiber cable from the outside, the tensile strength member may press a sheath (hereinafter, referred to as a TM inner sheath) between the tensile strength member and the cable core in a direction from the tensile strength member toward the cable core in the cross-sectional view. When the TM inner sheath becomes thin, damage such as a crack may occur.

When the sheath thickness is increased as a whole in order to increase the thickness of the TM outer sheath and the thickness of the TM inner sheath by a predetermined value or more, the average outer diameter of the cable increases, and it is difficult to reduce the diameter of the cable.

### SUMMARY OF INVENTION

Aspect of non-limiting embodiments of the present disclosure relates to provide an optical fiber cable with a reduced diameter in which the sheath is less likely to be damaged and the pumping distance can be extended.

Aspects of certain non-limiting embodiments of the present disclosure address the features discussed above and/or other features not described above. However, aspects of the non-limiting embodiments are not required to address the above features, and aspects of the non-limiting embodiments of the present disclosure may not address features described above.

According to an aspect of the present disclosure, there is provided an optical fiber cable including:
a cable core including a plurality of optical fibers;
at least one tensile strength member provided along an axis of the cable core; and
a sheath covering the cable core from an outside and containing the tensile strength member,
in which the sheath is flattened such that a long axis of the sheath overlaps a position where the tensile strength member is provided with respect to the cable core, in a cross-sectional view orthogonal to an axis of the optical fiber cable,
a circularity of an outer diameter of the cable core is larger than a circularity of a surface layer of the sheath, and
the circularity of the surface layer of the sheath is 85% or more and 96% or less, in the cross-sectional view.

### BRIEF DESCRIPTION OF DRAWINGS

Exemplary embodiment(s) of the present invention will be described in detail based on the following FIGURE, wherein:

The FIGURE is a cross-sectional view exemplifying an optical fiber cable according to the present embodiment.

### DESCRIPTION OF EMBODIMENTS

### Description of Embodiment of Present Disclosure

First, an embodiment of the present disclosure will be listed and described.

(1) An optical fiber cable according to one aspect of the present disclosure including:
a cable core including a plurality of optical fibers; at least one tensile strength member provided along an axis of the cable core; and a sheath covering the cable core from an outside and containing the tensile strength member, in which the sheath is flattened such that a long axis of the sheath overlaps a position where the tensile strength member is provided with respect to the cable core, in a cross-sectional view orthogonal to an axis of the optical fiber cable, in which a circularity of an outer diameter of the cable core is larger than a circularity of a surface layer of the sheath, and in which the circularity of the surface layer of the sheath is 85% or more and 96% or less in the cross-sectional view.

According to the present disclosure, in the cross-sectional view, the sheath is flattened such that the long axis of the sheath overlaps the position where the tensile strength member is provided with respect to the cable core, the circularity of the outer diameter of the cable core is larger than the circularity (hereinafter, also referred to as the circularity of the sheath) of the surface layer of the sheath, and the circularity of the sheath is 96% or less. Therefore, the thickness of the TM outer sheath can be made equal to or larger than the thickness defined by the standard. Since the TM inner sheath can also be thickened, the TM inner sheath is less likely to be damaged even when pressure is applied from the outside. Since the circularity of the sheath is 85% or more, the airtightness between the cable and the inner surface of the cable insertion tube of the cable pump is less likely to be impaired, and the pumping distance can be extended. Further, as compared with the case in which both the circularity of the outer diameter of the cable core and the circularity of the sheath are large, the sheath is made thick only at the location where the tensile strength member is provided. Therefore, the average sheath thickness is small and the diameter of the cable is easily reduced.

(2) In the above (1), in the cross-sectional view, the tensile strength members may be provided at two locations that face each other across the cable core.

According to the present disclosure, since the outer diameter of the tensile strength member can be reduced as compared with the case in which the tensile strength member is provided at one location, it is easy to further reduce the diameter of the cable.

(3) In the above (1) or (2), the sheath may be made of high-density polyethylene.

According to the present disclosure, since the sheath is made of high-density polyethylene, the mechanical strength of the sheath is high, and the sheath is less likely to be crushed.

(4) In any one of the above (1) to (3), the tensile strength member may be made of fiber reinforced plastic. An outer diameter of the tensile strength member may be 1.9 mm or less.

According to the present disclosure, since the tensile strength member is made of fiber reinforced plastic, the strength of the optical fiber cable can be increased even when the outer diameter of the tensile strength member is as small as 1.9 mm or less.

### Details of Embodiment

Hereinafter, an optical fiber cable 1 according to an embodiment (hereinafter referred to as the present embodiment) of the present disclosure will be described with reference to the FIGURE. The dimensions of members shown in each drawing are for convenience of description and may be different from actual dimensions of the members.

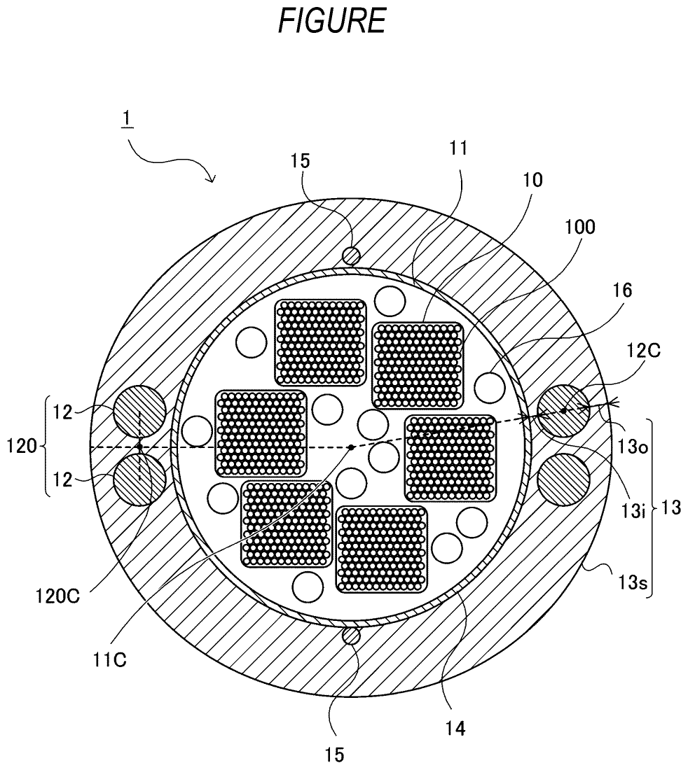

The FIG. 1s a cross-sectional view exemplifying the optical fiber cable 1 according to the present embodiment. The cross section of the optical fiber cable 1 shown in the FIG. 1s a cross section orthogonal to the axis of the optical fiber cable 1. As shown in the FIGURE, the optical fiber cable 1 includes a cable core 11, at least one tensile strength member 12, a sheath 13, a press wrapping tape 14, and at least one tear string 15. The optical fiber cable 1 is, for example, a slotless optical fiber cable, and is a cable for air pumping that is air-pumped through a duct such as a micro-duct. The outer diameter of the optical fiber cable 1 is, for example, 17.5 mm.

The cable core 11 includes a plurality of optical fibers or a plurality of optical fiber ribbons 100. In the present embodiment, the cable core 11 includes, for example, six optical fiber units 10 each including 12 optical fiber ribbons 100. One optical fiber ribbon 100 includes, for example, 12 optical fibers. The outer diameter of each of the optical fibers is, for example, 250 μm. The 12 optical fibers are arranged in a direction orthogonal to the axis. Among at least a part of adjacent optical fibers of the optical fiber ribbon 100, a connecting portion in a state in which the adjacent optical fibers are connected and a non-connecting portion in a state in which the adjacent optical fibers are not connected are intermittently provided in the longitudinal direction of the optical fiber.

Each of the optical fiber ribbons 100 provided in the optical fiber unit 10 may be in a rounded shape in the cross-sectional view. A plurality of optical fibers or a plurality of optical fiber ribbons may be bundled together such that the outer shape of each optical fiber unit 10 in the cross-sectional view is rounded. The FIG. 1s a diagram schematically showing a cable structure, and is not intended to show specific arrangement and dimensions of each component. For example, the optical fiber unit 10 may be accommodated inside the press wrapping tape 14 such that the gap around the optical fiber unit 10 is smaller.

The outer diameter of the cable core 11 is, for example, 12.7 mm. The cable core 11 may include a plurality of water absorbing members 16 in addition to the optical fiber unit 10.

The press wrapping tape 14 is wound around the outer periphery of the cable core 11. As the press wrapping tape 14, a tape formed of a nonwoven fabric, a tape obtained by laminating a base material such as polyethylene terephthalate (PET) and a nonwoven fabric, or the like can be used. The press wrapping tape 14 may be provided with a function as a water absorbing material using a water absorbing powder or the like. When the press wrapping tape 14 functions as a water absorbing material, the water absorbing member 16 may not be provided. Instead of the press wrapping tape 14, a bundling string may be wound around the outer periphery of the cable core 11.

At least one tensile strength member 12 is provided along the cable core 11. The tensile strength member 12 may be linearly provided along the axis of the cable core 11 in the axis of the optical fiber cable 1. The tensile strength member 12 is embedded in the sheath 13. The tensile strength member 12 is preferably provided inside the sheath 13 at a position close to the cable core 11 rather than the surface layer of the sheath 13.

The tensile strength member 12 is made of a fiber reinforced plastic (FRP). Examples of the fiber reinforced plastic include aramid FRP, glass FRP, and carbon FRP. The tensile strength member 12 has a circular shape in the cross-sectional view. The diameter of the tensile strength member 12 is, for example, 1.8 mm or more and 1.9 mm or less.

In the present embodiment, the tensile strength members 12 form pairs, each pair including two the tensile strength members 12. In the following description, the paired two tensile strength members 12 are collectively referred to as a tensile strength member set 120. In the present embodiment, in the cross-sectional view, the tensile strength member sets 120 are provided at two locations (positions symmetrical with respect to the cable center) that face each other across the cable core 11. Further, in one tensile strength member set 120, the paired two tensile strength members 12 are separated from each other by, for example, 0.3 mm or more.

The tear string 15 is provided for tearing the sheath 13 and taking out the optical fiber unit 10 inside the cable core 11, and is provided along the cable core 11. In the present embodiment, the tear strings 15 are provided at two locations that face each other across the cable core 11. Each tear string 15 is provided at a substantially intermediate position between the two tensile strength member sets 120. The tear string 15 has a fiber shape, and is made of, for example, a plastic material resistant to tension.

The sheath 13 covers the cable core 11 from the outside and contains the tensile strength member 12 and the tear string 15. The base resin of the sheath 13 according to the present embodiment is made of high-density polyethylene. The sheath 13 may contain a flame-retardant inorganic material. As a flame-retardant inorganic material, the sheath 13 contains, for example, magnesium hydroxide or aluminum hydroxide.

In the present embodiment, in the cross-sectional view orthogonal to the axis of the optical fiber cable 1, the sheath 13 is flattened such that the long axis of the sheath 13 overlaps the position where the tensile strength member set 120 is provided with respect to the cable core 11. In other words, the sheath 13 has an elliptical shape, and the long axis of the sheath 13 is on a straight line that passes through the centers of the two tensile strength member sets 120 provided with the cable core 11 interposed therebetween. For example, the sheath 13 is flattened such that the long axis of the sheath 13 is substantially on a straight line that connects a center 11C of the cable core 11 and a middle 120C of the two tensile strength members 12 paired in one tensile strength member set 120.

The sheath 13 includes a TM outer sheath 130 and a TM inner sheath 13i. The TM outer sheath 130 is a sheath portion between the tensile strength member 12 and a surface layer 13s of the sheath 13 in a direction from the tensile strength member 12 toward the surface layer 13s of the sheath 13, in the cross-sectional view orthogonal to the axis of the optical fiber cable 1. More specifically, the TM outer sheath 130 is a sheath portion between the tensile strength member 12 and the surface layer 13s of the sheath 13 on a straight line that passes through the center 11C of the cable core 11 and a center 12C of the tensile strength member 12, in the cross-sectional view. The thickness of the TM outer sheath 130 is, for example, 0.67 mm. The TM inner sheath 13i is a sheath portion between the tensile strength member 12 and the cable core 11 in a direction from the tensile strength member 12 toward the cable core 11, in the cross-sectional view. More specifically, the TM inner sheath 13i is a sheath portion between the tensile strength member 12 and the cable core 11 on a straight line that passes through the center 11C of the cable core 11 and the center 12C of the tensile strength member 12 in the cross-sectional view. The thickness of the TM inner sheath 13i is, for example, 0.36 mm.

Next, the circularity in the present embodiment will be described. In the present embodiment, for example, in the case of the circularity of the surface layer of the sheath 13, the “circularity” is defined by a ratio ((short diameter/long diameter)×100%) between the longest diameter (hereinafter referred to as a long diameter) and the shortest diameter (hereinafter referred to as a short diameter) of the outer diameters of the surface layer of the sheath 13, in the cross-sectional view orthogonal to the axis of the optical fiber cable 1. The same applies to the case of the circularity of the cable core 11, and the circularity is defined by the ratio ((short diameter/long diameter)×100%) between the long diameter and the short diameter of the outer diameters of the cable core 11. The larger the value of the circularity of the outer diameters of the cable core 11, the closer the outer shape of the cable core 11 is to a perfect circle.

In the present embodiment, in the cross-sectional view orthogonal to the axis of the optical fiber cable 1, the circularity of the outer diameters of the cable core 11 is larger than the circularity of the sheath 13. Further, in the cross-sectional view, the circularity of the sheath 13 is 85% or more and 96% or less. For example, the circularity of the outer diameters of the cable core 11 is 100%, and the circularity of the sheath 13 is 96%.

As described above, in the present embodiment, in the cross-sectional view of the optical fiber cable 1, the sheath 13 is flattened such that the long axis of the sheath 13 overlaps the position where the tensile strength member 12 is provided with respect to the cable core 11. Further, the circularity of the outer diameters of the cable core 11 is larger than the circularity of the sheath 13, and the circularity of the sheath 13 in the cross-sectional view is 85% or more and 96% or less.

In the optical fiber cable 1 in which the sheath 13 contains the tensile strength member 12, the thickness of the TM outer sheath 130 in the cross-sectional view needs to be a thickness defined by the standard, for example, 0.5 mm or more. When pressure is applied to the optical fiber cable 1 from the outside, the tensile strength member 12 may press the TM inner sheath 13i in the cross-sectional view. When the TM inner sheath 13i becomes thin, damage such as a crack may occur in the TM inner sheath 13i due to being pressed by the tensile strength member 12.

When the thickness of the sheath 13 is increased as a whole in order to increase the thickness of the TM outer sheath 130 and the thickness of the TM inner sheath 13i by a predetermined value or more, the average outer diameter of the optical fiber cable 1 increases, and it is difficult to reduce the diameter of the optical fiber cable 1. However, according to the present embodiment, the optical fiber cable 1 with a reduced diameter is provided in which the sheath 13 is less likely to be damaged and the pumping distance can be extended.

### Evaluation Experiment 1

Hereinafter, the present embodiment will be described in more detail by showing the results of evaluation tests using examples and comparative examples according to the present embodiment. The present disclosure is not limited to these examples.

In an evaluation experiment 1, whether damage occurs to the TM inner sheath 13i when pressure is applied to the optical fiber cable 1 from the outside was evaluated by actual measurement and simulation. More specifically, first, as comparative examples, a sample No. 1 and a sample No. 2 of actual optical fiber cables were prepared, a force of 2200 N was applied from the outside for one minute, and the thickness of the TM inner sheath 13i and the deformation amount of the average outer diameter of the sheath 13 when a crack occurred in the TM inner sheath 13i were measured. The presence or absence of a crack was checked by visually observing the cross section of the optical fiber cable and using a microscope, and a relational expression was derived between the thickness of the TM inner sheath 13i and the deformation amount of the average outer diameter of the sheath 13 in order to prevent a crack from occurring. Further, by simulation, a sample No. 3 and a sample No. 4 that serve as examples were prepared, and the deformation amount of the average outer diameter of the sheath 13 was calculated under the condition that no crack occurs in the TM inner sheath 13i even when a force of 2200 N was applied to the optical fiber cable 1 from the outside for one minute. The measurement results and the simulation results are shown in Table 1.

TABLE 1

| | Sample | Sample | Sample | Sample |
|---|---|---|---|---|
| Items | No. 1 | No. 2 | No. 3 | No. 4 |
| Long diameter [mm] of cable core | 14.1 | 13.64 | 12.7 | 12.7 |
| Short diameter [mm] of cable core | 13.31 | 12.08 | 12.7 | 12.7 |
| Long diameter [mm] of sheath | 19.41 | 18.41 | 18.42 | 18.62 |
| Short diameter [mm] of sheath | 18.79 | 17.43 | 17.7 | 15.83 |
| Average outer diameter [mm] of sheath | 19.1 | 17.92 | 18.06 | 17.23 |
| Average coating thickness [mm] | 2.573 | 2.569 | 2.68 | 2.26 |
| Circularity (%) of cable core | 94.4 | 88.6 | 100 | 100 |
| Circularity (%) of sheath | 96.8 | 94.7 | 96 | 85 |
| Thickness [mm] of TM inner sheath | 0.091 | 0.265 | 0.36 | 0.52 |
| Amount [mm] of change in average outer | 1 | 3.6 | 5.02 | 7.41 |
| diameter of sheath when no crack occurs | | | | |
| Amount [mm] of change when loading | 6.07 | 5.78 | 4.82 | 7.38 |
| at 2200N × 1 min | | | | |

The sample No. 1 and the sample No. 2 are comparative examples, and show the evaluation results obtained by actual measurement. In the sample No. 1 and the sample No. 2, the cable core 11 is flattened, and the sheath 13 is also flattened.

In the sample No. 1, the limit value of the amount of change in the average outer diameter of the sheath 13 in the case in which no crack occurs in the TM inner sheath 13i was 1 mm. In the sample No. 1, since the amount of change in the average outer diameter of the sheath 13 when a force of 2200 N was applied for one minute was 6.07 mm, pressure exceeding the limit value was applied to the optical fiber cable, and a crack occurred in the TM inner sheath 13i.

In the sample No. 2, the limit value of the amount of change in the average outer diameter of the sheath 13 in the case in which no crack occurs in the TM inner sheath 13i was 3.6 mm. In the sample No. 2, since the amount of change in the average outer diameter of the sheath 13 when a force of 2200 N was applied for one minute was 5.78 mm, pressure exceeding the limit value was applied to the optical fiber cable, and a crack occurred in the TM inner sheath 13i.

From the sample No. 1 and the sample No. 2, the following formula 1 was derived as a relational expression between the thickness of the TM inner sheath 13i and the amount of change in the average outer diameter of the sheath 13, which is a limit value at which no crack occurs. In the formula 1, x is the thickness of the TM inner sheath 13i. Further, y is the amount [mm] of change in the average outer diameter of the sheath 13, which is a limit value at which no crack occurs when a force of 2200 N was applied to the optical fiber cable from the outside for one minute. C is a correction coefficient.

$$y = 14.943 x + C \qquad ( Formula 1 )$$

The sample No. 3 and the sample No. 4 are examples, and show the simulation results. In the sample No. 3 and the sample No. 4, the long diameter and the short diameter of the cable core 11 are both 12.7 mm, and the circularity of the cable core 11 is 100%. In other words, in the sample No. 3 and the sample No. 4, the cable core 11 is a perfect circle and is not flattened.

In the sample No. 3, the circularity of the sheath 13 is 96%, and the sheath 13 is flattened. In the sample No. 3, the circularity (100%) of the cable core 11 is larger than the circularity (96%) of the sheath 13. The thickness of the TM inner sheath 13i is 0.36 mm. In the sample No. 3, the amount of change in the average outer diameter of the sheath 13, which is a limit value at which no crack occurs when a force of 2200 N was applied to the optical fiber cable 1 from the outside for one minute, was calculated to be 5.02 mm based on the formula 1.

In the sample No. 4, the circularity of the sheath 13 was 85%, and the sheath 13 was flattened. In the sample No. 4, the circularity (100%) of the cable core 11 is larger than the circularity (85%) of the sheath 13. The thickness of the TM inner sheath 13i is 0.52 mm. In the sample No. 4, the amount of change in the average outer diameter of the sheath 13, which is a limit value at which no crack occurs when a force of 2200 N was applied to the optical fiber cable 1 from the outside for one minute, was calculated to be 7.41 mm based on the formula 1.

When the optical fiber cable 1 is regarded as a single pipe, the amount of change in the average outer diameter of the sheath 13 when pressure is applied to the optical fiber cable 1 from the outside can be calculated as follows. Specifically, the average outer diameter of the sheath 13 of the optical fiber cable 1 is regarded as the average outer diameter of the pipe, and the average outer diameter of the cable core 11 is regarded as the average inner diameter of the pipe. Further, from the sample No. 1 and the sample No. 2, the following formula 2 is derived as a relational expression between the force applied to the pipe from the outside and the amount of change in the average outer diameter of the pipe. In the formula 2, F is a load [kg] applied to the pipe from the outside, and here, 2200 N/9.8=224.5 kg. OD is the average outer diameter of the pipe, in other words, the average outer diameter [mm] of the sheath 13. ID is the average inner diameter of the pipe, in other words, the average outer diameter [mm] of the cable core 11. E is the Young's modulus of the material of the sheath 13. L is the length [mm] of the pipe on the axis. A is the outer diameter correction coefficient.

$$A * 2 * F * ( π / 8 - 1 / π ) * \{ ( OD + ID ) / 4 \} \hat{} 3 / [ E * L * \{ ( OD - ID ) / 2 \} \hat{} 3 / 12 ] \qquad ( Formula 2 )$$

According to the formula 2 derived from the sample No. 1 and the sample No. 2, in the sample No. 3, it is calculated that the amount of change in the average outer diameter of the sheath 13 when no crack occurs in the TM inner sheath 13i even when a force of 2200 N is applied to the optical fiber cable 1 from the outside for one minute is 4.82 mm. The calculated value of 4.82 mm is smaller than the amount of change in the average outer diameter of the sheath 13 used in the evaluation experiment 1, which was 5.02 mm when no crack occurred. Therefore, it was also confirmed that no crack occurs in the TM inner sheath 13i in the sample No. 3 in the evaluation using the formula 2.

Similarly, according to the formula 2, in the sample No. 4, it is calculated that the amount of change in the average outer diameter of the sheath 13 when no crack occurs in the TM inner sheath 13i even when a force of 2200 N is applied to the optical fiber cable 1 from the outside for one minute is 7.38 mm. The calculated value of 7.38 mm is smaller than the amount of change in the average outer diameter of the sheath 13 used in the evaluation experiment 1, which was 7.41 mm when no crack occurred. Therefore, it was also confirmed that no crack occurs in the TM inner sheath 13i in the sample No. 4 in the evaluation using the formula 2.

As described above, it was confirmed that when the circularity of the cable core 11 is larger than the circularity of the sheath 13 and the circularity of the sheath 13 is 85% or more and 96% or less, no crack occurs in the TM inner sheath 13i even when a force of 2200 N is applied to the optical fiber cable 1 from the outside for one minute.

The foregoing description of the exemplary embodiments of the present invention has been provided for the purposes of illustration and description. It is not intended to be exhaustive or to limit the invention to the precise forms disclosed. Obviously, many modifications and variations will be apparent to practitioners skilled in the art. The embodiments were chosen and described in order to best explain the principles of the invention and its practical applications, thereby enabling others skilled in the art to understand the invention for various embodiments and with the various modifications as are suited to the particular use contemplated. It is intended that the scope of the invention be defined by the following claims and their equivalents.

In the embodiment described above, the tensile strength member sets 120 are arranged at two locations that face each other with the cable core 11 interposed therebetween, but the arrangement of the tensile strength members 12 is not limited thereto. One tensile strength member 12 may be provided at two locations that face each other with the cable core 11 interposed therebetween. In this case, the sheath 13 is flattened in the direction in which the two tensile strength members 12 are provided with respect to the cable core 11. In other words, the sheath 13 has an elliptical shape, and the long axis of the sheath 13 is in the direction in which the two tensile strength members 12 provided with the cable core 11 interposed therebetween are aligned.

One tensile strength member 12 may be provided at one location in the sheath 13. In this case, the sheath 13 is also flattened such that the long axis of the sheath 13 is in the direction from the center 11C of the cable core 11 toward the center of the one tensile strength member 12. Similarly, one tensile strength member set 120 may be provided at one location in the sheath 13. In this case, the sheath 13 is also flattened such that the long axis of the sheath 13 is in the direction from the center 11C of the cable core 11 toward the middle 120C of the paired two tensile strength members 12.

In the embodiment described above, in the one tensile strength member set 120, the paired two tensile strength members 12 are separated from each other, but the arrangement of the two tensile strength members 12 is not limited thereto. In the one tensile strength member set 120, the paired two tensile strength members 12 may be in contact with each other.

What is claimed is:

1. An optical fiber cable comprising:
a cable core including a plurality of optical fibers;
at least one tensile strength member provided along an axis of the cable core; and
a sheath covering the cable core from an outside and containing the tensile strength member,
wherein the sheath is flattened such that a long axis of the sheath overlaps a position where the tensile strength member is provided with respect to the cable core, in a cross-sectional view orthogonal to an axis of the optical fiber cable,
wherein a circularity of an outer diameter of the cable core is larger than a circularity of a surface layer of the sheath, and
wherein the circularity of the surface layer of the sheath is 85% or more and 96% or less, in the cross-sectional view.

2. The optical fiber cable according to claim 1,
wherein in the cross-sectional view, the tensile strength members are provided at two locations that face each other across the cable core.

3. The optical fiber cable according to claim 1,
wherein the sheath is made of high-density polyethylene.

4. The optical fiber cable according to claim 1,
wherein the tensile strength member is made of fiber reinforced plastic, and
wherein an outer diameter of the tensile strength member is 1.9 mm or less.
